(19) United States
(12) Patent Application Publication
(10) Pub. No.: US 2025/0140434 A1
(43) Pub. Date: May 1, 2025

(54) DYNAMIC SIGNAL CONTROL SYSTEMS AND METHODS

(71) Applicant: Quantinuum LLC, Broomfield, CO (US)

(72) Inventors: Leonardo Ascarrunz, Lafayette, CO (US); Kyle Stephen McKay, Broomfield, CO (US); Christopher N. Gilbreth, Erie, CO (US)

(21) Appl. No.: 18/902,387

(22) Filed: Sep. 30, 2024

Related U.S. Application Data
(60) Provisional application No. 63/546,624, filed on Oct. 31, 2023.

(51) Int. Cl. G21K 1/087; G06N 10/20

(52) U.S. Cl. CPC G21K 1/087; G21K 1/003

(57) ABSTRACT

Various embodiments provide methods, apparatuses, systems, or computer program products for providing dynamic control of a signal. In an example embodiment, a system comprises a signal generator, a controller configured to control operation of the signal generator, a first signal path between the signal generator and an output connected to an electrode of an ion trap, and a selectively connectable second signal path between the signal generator and the output to bypass the low pass filter. The signal generator is configured to generate a signal comprising a first frequency component having a first range of frequencies and/or a second frequency component having a second range of frequencies higher than the first range of frequencies. The first signal path comprises a low pass filter to filter noise above the first range of frequencies. The second signal path comprises a bandpass filter to permit the second frequency component to pass from the signal generator to the output.

### CROSS-REFERENCE TO RELATED APPLICATIONS

This application claims priority to and the benefit of U.S. Provisional Patent Application Ser. No. 63/546,624, filed Oct. 31, 2023, and titled “DYNAMIC SIGNAL CONTROL SYSTEMS AND METHODS,” which is incorporated herein by reference in its entirety.

### TECHNICAL FIELD

Various embodiments relate to apparatuses, systems, and methods for providing dynamic signal control. For example, some example embodiments relate to providing dynamic control of a signal applied to an electrode of an ion trap.

### BACKGROUND

In various scenarios, a system having electrical components may be configured to perform multiple functions and different functions may have different tolerances for the noise present in the signals applied to various electrical components. For example, an atomic object trap can use a combination of electrical and magnetic fields to capture a plurality of atomic objects (e.g., ions) in a potential well. Various functions may be performed to cause the atomic object to move in particular ways through portions of the atomic object trap and/or be contained in a particular portion of the atomic object trap. These various functions, which may be termed transport functions, may have differing noise tolerances in the signals used to generate the combination of electrical and magnetic fields.

U.S. Pat. No. 11,025,228, issued Jun. 1, 2021, and titled DYNAMIC NOISE SHAPING FILTERS AND CORRESPONDING METHODS, the contents of which are incorporated herein in its entirety, provides a solution for providing different control signals to perform different functions having different noise tolerances. U.S. Pat. No. 11,025,228 provides dynamic noise shaping filters that are capable of filtering the signal in different ways depending on the desired movement of the atomic object in the atomic object trap and the noise tolerances associated with such corresponding control signals. While the dynamic noise filters of U.S. Pat. No. 11,025,228 provided a solution for dynamic filtering of control signals to perform one or more different transport functions, the dynamic filters of U.S. Pat. No. 11,025,228 may not work for all types of signals that provide other types of functionality.

In various scenarios, it is desirable to cool atomic objects trapped by an atomic object trap such that various operations may be performed on the atomic objects (e.g., experiments, controlled quantum evolution, and/or the like). One such cooling technique is laser cooling. However, in various scenarios, some motional modes of the atomic objects cool very slowly, and thus, the cooling steps of the atomic objects take up a significant fraction of the run time. It is challenging to cool all the motional modes of the atomic objects efficiently via laser cooling. To improve the cooling of motional modes that cool slowly using laser cooling, a technique termed phonon pumping has been developed. Phonon pumping involves directing a high frequency AC signal at one or more atomic objects to redistribute the phonon population of the atomic object(s) to decrease the phonon population of a mode that is difficult to laser cool and increase the phonon population of a mode that is easier to laser cool. Laser cooling may then be performed on the easier to cool mode to decrease the overall phonon population of the atomic object(s). The high frequency AC signal typically comprises and/or is characterized by a difference frequency of the two modes. Phonon pumping is described in detail in U.S. patent application Ser. No. 18/469,740, filed Sep. 19, 2023, titled LASER COOLING ATOMIC OBJECTS WITH PHONON PUMPING, the contents of which are incorporated herein in its entirety.

By blocking frequencies outside of those required for the different transport functions, the dynamic filters of U.S. Pat. No. 11,025,228 prevent phonon pumping which is performed at much higher frequencies than those needed for the different transport functions.

Through applied effort, ingenuity, and innovation, many deficiencies of such prior ion traps have been solved by developing solutions that are structured in accordance with the embodiments of the present invention, many examples of which are described in detail herein.

### BRIEF SUMMARY OF EXAMPLE EMBODIMENTS

Example embodiments provide methods, systems, apparatuses, computer program products and/or the like for providing dynamic control of a signal applied to an electrical component of a system. According to a first aspect, a system for providing dynamic control of a signal is provided. In an example embodiment, the system comprises a signal generator, a controller configured to control operation of the signal generator, a first signal path between the signal generator and an output connected to an electrode of an ion trap, and a selectively connectable second signal path between the signal generator and the output to bypass the low pass filter of the first signal path. The signal generator is configured to generate a signal comprising a first frequency component having a first range of frequencies and/or a second frequency component having a second range of frequencies. The second range of frequencies is higher than the first range of frequencies. The ion trap is configured to trap a plurality of atomic objects therein. The first signal path comprises at least a low pass filter to filter noise above the first range of frequencies from the signal. The second signal path comprises at least a bandpass filter to permit the second frequency component to pass from the signal generator to the output.

In an example embodiment, the first frequency component of the signal controls an atomic object transport operation.

In an example embodiment, the atomic object transport operation comprises one or more of transporting an atomic object from one location within the ion trap to another location in the ion trap, maintaining an atomic object in a particular location within the ion trap so that a quantum logic gating operation may be performed on the atomic object, causing two atomic objects to swap positions within the ion trap, causing two atomic objects to move close together, and/or causing two atomic objects that are close together move apart from one another.

In an example embodiment, the second frequency component of the signal controls a phonon pumping operation that changes a a phonon distribution of an atomic object to decrease a phonon population of the atomic object in a mode that is slower to cool with laser cooling and to increase the phonon population of the atomic object in a mode that is faster to cool with laser cooling.

In an example embodiment, the second signal path further comprises switching circuitry to selectively connect the second signal path between the signal generator and the output. The controller is further configured to control operation of the switching circuitry.

In an example embodiment, the switching circuitry is positioned between the signal generator and the bandpass filter.

In an example embodiment, the second signal path further comprises at least one buffer positioned between the switching circuitry and the bandpass filter. The switching circuitry switches an input of the at least one buffer to ground when the second signal path is not connected between the signal generator and the output.

In an example embodiment, the first signal path and the second signal path are passively joined at the output.

In an example embodiment, the first signal path and the second signal path are actively joined at the output.

In an example embodiment, the first signal path further comprises a dynamic filter that is capable of switching between at least two responses. The controller is further configured to control selection of an operating response from the at least two responses of the dynamic filter, and to cause the activation of one or more switches of the dynamic filter to select the operating response from the at least two responses of the dynamic filter.

According to another aspect, a method for dynamically providing a signal in a system is provided. In an example embodiment, the method comprises causing, by a controller of the system, a signal generator to generate a signal comprising a first frequency component having a first range of frequencies and/or a second frequency component having a second range of frequencies, the second range of frequencies being higher than the first range of frequencies. The signal generated by the signal generator is provided to a first signal path between the signal generator and an output connected to an electrode of an ion trap. The ion trap is configured to trap a plurality of atomic objects therein. The first signal path comprises at least a low pass filter to filter noise above the first range of frequencies from the signal. The signal generated by the signal generator is provided to a selectively connectable second signal path between the signal generator and the output to bypass the low pass filter of the first signal path. The second signal path comprises at least a bandpass filter to permit the second frequency component to pass from the signal generator to the output.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a top view of an example atomic object confinement apparatus that may be used in example embodiment.

FIG. 2 is a block diagram illustrating a system for dynamically providing a signal to be applied to an electrode of an example atomic object confinement apparatus, in accordance with an example embodiment.

FIG. 3 is a flowchart illustrating processes, procedures, and/or operations for dynamically providing a signal to be applied to an electrode of an example atomic object confinement apparatus in an example quantum computing system, according to an example embodiment.

FIG. 4 is a schematic diagram illustrating an example quantum computing system comprising a quantum system controller according to an example embodiment.

FIG. 5 provides a schematic diagram of an example quantum system controller of a quantum computer.

FIG. 6 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits and/or within user measurement capabilities, unless otherwise indicated. Like numbers refer to like elements throughout.

In various embodiments, methods, apparatuses, systems, computer program products, and/or the like for generating and providing dynamic control of a signal applied to an electrical component of a system. For example, a signal may be generated (e.g., by a waveform generator or signal generator) and applied to an electrical component (e.g., electrode) of a system (e.g., a quantum computer). Application of the signal to the electrical component may cause the system to perform a function. In various embodiments, depending on the signal applied to the electrical component, the system may be configured to perform a variety of functions. In an example embodiment, different functions of the variety of functions may have different requirements regarding the frequency of the signal and/or the amount and/or the frequency of noise in the applied signal that can be tolerated.

In various embodiments, the generated signal to be provided to the electrical components may comprise a first frequency component having a first range of frequencies and/or a second frequency component having a second range of frequencies, where the second range of frequencies is higher than the first range of frequencies. In various embodiments, the first frequency component of the signal controls an atomic object transport operation. In various embodiments, the second frequency component of the signal controls a phonon pumping operation that changes a mode of an atomic object to cool the atomic object.

In various embodiments, a first signal path is provided between a signal generator and an output connected to an electrode of an ion trap, and a selectively connectable second signal path is provided between the signal generator and the output. In various embodiments, the first signal path comprises a low pass filter and/or a dynamic filter (such as is disclosed in U.S. Pat. No. 11,025,228). In various embodiments, the low pass filter and/or dynamic filter of the first signal path filters undesirable noise from the signal that might negatively affect the transport operation. In various embodiments, the low pass filter and/or dynamic filter would block the second frequency component from passing from the signal generator to the output along the first signal path.

In various embodiments, the selectively connectable second signal path comprises at least a bandpass filter to permit the second frequency component to pass from the signal generator to the output. In this regard, the selectively connectable second signal path, when connected, bypasses the low pass filter and/or dynamic filter of the first signal path.

In various embodiments, if the signal does not comprise a second frequency component (in addition to or instead of the first frequency component) for phonon pumping, the second signal path is not connected between the signal generator and the output. In various embodiments, if the signal does comprise a second frequency component (in addition to or instead of the first frequency component) for phonon pumping, the second signal path is connected between the signal generator and the output to enable the second frequency component to reach the output. In various embodiments, without the second signal path, the low pass filter and/or dynamic filter of the first signal path would block the second frequency component from reaching the output.

In an example embodiment, the system is a quantum computer. For example, the system may a trapped ion quantum computer comprising an ion trap comprising a plurality of electrodes. Application of voltage signals to the electrodes may cause the ion trap to perform various functions corresponding to moving or maintaining atomic objects (e.g., ions, atoms, and/or the like) trapped within the ion trap. For example, the various functions may include transporting atomic objects from one location within the ion trap to another location in the ion trap, maintaining an atomic object in a particular location within the ion trap so that quantum logic gate may be performed on the atomic object, causing two atomic objects to swap positions within the ion trap, cause two atomic objects to move close together, cause two atomic objects that are close together move apart from one another, and/or the like. Such functions may be termed transport functions. Application of voltage signals to the electrodes may, additionally or alternatively, cause phonon pumping in which the phonon population of one or more atomic objects is redistributed from a mode that is difficult to laser cool to a mode that is easier to laser cool.

### Exemplary Atomic Object Confinement Apparatus

In an example embodiment, the system is or comprises an atomic object confinement apparatus (also referred to as a confinement apparatus and/or atomic object trap herein). In an example embodiment, the confinement apparatus is an ion trap (e.g., a surface ion trap). For example, the ion trap may comprise a plurality of electrodes configured to receive electrical signals (e.g., voltages) so as to generate a potential field that controls the movement of one or more atomic objects (e.g., ions) within the ion trap.

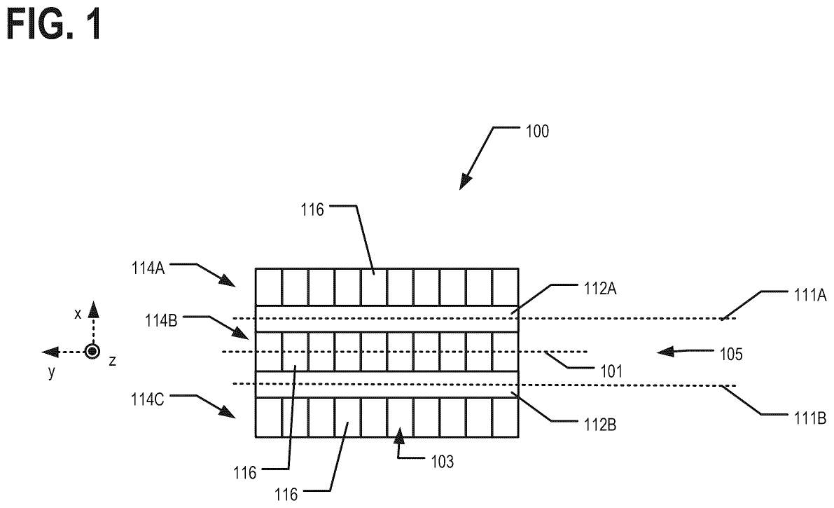

FIG. 1 provides a top schematic view of an example surface ion trap 100. In an example embodiment, the surface ion trap 100 is fabricated as part of an ion trap chip and/or part of an ion trap apparatus and/or package. In an example embodiment, the surface ion trap 100 is at least partially defined by a number of radio frequency (RF) rails 112 (e.g., 112A, 112B). In various embodiments, the ion trap 100 is at least partially defined by a number of sequences of trapping and/or transport (TT) electrodes 114 (e.g., 114A, 114B, 114C). In an example embodiment, the ion trap 100 is a surface Paul trap with symmetric RF rails. In various embodiments, the potential generating elements of the confinement apparatus comprise the TT electrodes 116 of the sequences of TT electrodes 114 and/or the RF rails 112. In various embodiments, the upper surface of the ion trap 100 has a planarized topology. For example, the upper surface of each RF rail 112 of the number of RF rails 112 and the upper surface of each TT electrode 116 of the number of sequences of TT electrodes 114 may be substantially coplanar.

In various embodiments, the ion trap 100 comprises and/or is at least partially defined by a number of RF rails 112. The RF rails 112 are formed with substantially parallel longitudinal axes 111 (e.g., 111A, 111B) and with substantially coplanar upper surfaces. For example, the RF rails 112 are substantially parallel such that a distance between the RF rails 112 is approximately constant along the length of the RF rails 112 (e.g., the length of an RF rail being along the longitudinal axes 111 of RF rail 112). For example, the upper surfaces of the RF rails 112 may be substantially flush with the upper surface of the ion trap 100. In an example embodiment, the number of RF rails 112 comprises two RF rails 112 (e.g., 112A, 112B). In various embodiments, the ion trap 100 may comprise a plurality of number of RF rails 112. For example, the ion trap 100 may be a two-dimensional ion trap that comprises multiple numbers (e.g., pairs and/or sets) of RF rails 112 with each number (e.g., pair and/or set) of RF rails 112 having substantially parallel longitudinal axes 111. In an example embodiment, a first number of RF rails 112 have mutually substantially parallel longitudinal axes 111, a second number of RF rails 112 have mutually substantially parallel longitudinal axes 111, and the longitudinal axes of the first number of RF rails and the longitudinal axes of the second number of RF rails are substantially non-parallel (e.g., transverse). FIG. 1 illustrates an example one dimensional ion trap 100 having two RF rails 112, though other embodiments may comprise additional RF rails in various configurations.

In various embodiments, two adjacent RF rails 112 may be separated (e.g., insulated) from one another by a longitudinal gap 105. For example, the longitudinal gap may define (in one or two dimensions) the confinement channel or region of the ion trap 100 in which one or more atomic objects (e.g., ions in the case of the confinement apparatus being an ion trap 100) may be trapped at various locations within the ion trap. In various embodiments, the longitudinal gap 105 defined thereby may extend substantially parallel to the longitudinal axes 111 of the adjacent RF rails 112. For example, the longitudinal gap 105 may extend substantially parallel to the y-axis. In an example embodiment, the longitudinal gap 105 may be at least partially filled with an insulating material (e.g., a dielectric material). In various embodiments, the dielectric material may be silicon dioxide (e.g., formed through thermal oxidation) and/or other dielectric and/or insulating material. In various embodiments, the longitudinal gap 105 has a height (e.g., in the x-direction) of approximately 40 μm to 500 μm. In various embodiments, one or more sequences of TT electrodes 114 (e.g., a second sequence of TT electrodes 114B) may be disposed and/or formed within the longitudinal gap 105.

In an example embodiment, a transverse gap may exist between neighboring and/or adjacent electrodes 116 of the one or more sequences of electrodes 114. In an example embodiment, the transverse gap may be empty space and/or at least partially filled with a dielectric material to prevent electrical communication between neighboring and/or adjacent electrodes. In an example embodiment, the transverse gap between neighboring and/or adjacent electrodes may be in the range of approximately 1-10 μm.

In an example embodiment, a longitudinal gap exists between a sequence of TT electrodes 114 and a neighboring and/or adjacent RF rail 112. In an example embodiment, the longitudinal gap may be at least partially filled with a dielectric and/or insulating material to prevent electrical communication between TT electrodes 116 of the sequence of electrodes 114 and the RF rail 112. In an example embodiment, the longitudinal gap between neighboring and/or adjacent electrodes may be in the range of approximately 1-10 μm.

In various embodiments, the ion trap 100 may be at least partially defined by a number of sequences of TT electrodes 114 (e.g., first sequence of TT electrodes 114A, second sequence of electrodes 114B, third sequence of TT electrodes 114C). Each sequence of TT electrodes 114 is formed to extend substantially parallel to the substantially parallel longitudinal axes 111 of the RF rails 112. For example, the number of sequences of TT electrodes 114 may extend substantially parallel to the y-axis as shown in FIG. 1. In various embodiments, the number of sequences of TT electrodes 114 comprises two, three, four, and/or another number of sequences of TT electrodes 114. In an example embodiment, the ion trap 100 comprises a plurality of number of sequences of TT electrodes 114. For example, the illustrated ion trap 100 is a one-dimensional ion trap comprising three sequences of TT electrodes 114. For example, the ion trap 100 may be a two-dimensional ion trap that comprises multiple numbers of sequences of TT electrodes 114 that each extend substantially parallel to a substantially parallel longitudinal axes of a corresponding number of RF rails 112. In an example embodiment, a first number of sequences of TT electrodes 114 extend substantially parallel to the substantially parallel longitudinal axes 111 of a first number of RF rails 112, a second number of sequences of TT electrodes 114 extend substantially parallel to the substantially parallel longitudinal axes 111 of a second number of RF rails 112, and the longitudinal axes of the first number of RF rails and the longitudinal axes of the second number of RF rails are substantially non-parallel (e.g., transverse). In some embodiments, each of the TT electrodes 116 of the number of sequences of TT electrodes 114 can be formed with substantially coplanar upper surfaces that are substantially coplanar with the upper surfaces of the RF rails 112.

In an example embodiment, a number (e.g., pair) of RF rails 112 may be formed between a first sequence of TT electrodes 114A and a third sequence of TT electrodes 114C with a second sequence of TT electrodes 114B extending along the longitudinal channel or gap 105 between the RF rails 112. For example, each sequence of TT electrodes 114 may extend in a direction substantially parallel to the longitudinal axes 111 of the RF rails (e.g., in the y-direction). In various embodiments, the upper surfaces of the sequences of TT electrodes 114 are substantially coplanar with the upper surfaces of the RF rails 112.

In various embodiments, RF signals may be applied to the RF rails 112 to generate an electric and/or magnetic field that acts to maintain an ion trapped within the ion trap 100 in directions transverse to the longitudinal direction of the ion trap 100 (e.g., the x- and z-directions). In various embodiments, TT voltages may be applied to the TT electrodes 116 to generate a time-dependent electric potential field that causes the objects of the group of objects to traverse corresponding trajectories to perform a deterministic reshaping and/or reordering function. In various embodiments, the number of sequences of TT electrodes 114 may, in combination, be biased, with TT voltages that contribute to a variable combined electrical and/or magnetic field to trap at least one atomic object (e.g., ion) in a potential well above at least one of either an upper surface of the sequences of TT electrodes 114 and/or the RF rails 112. For example, the electrical and/or magnetic field generated at least in part by voltages applied to the TT electrodes of the sequences of TT electrodes 114 may trap at least one atomic object in a potential well above the upper surface of the second sequence of TT electrodes 114B and/or the longitudinal gap 105. Additionally, the TT voltages applied to the electrodes 116 may cause ions trapped within the potential well above the upper surface of the second sequence of TT electrodes 114B and/or the longitudinal gap 105 to traverse trajectories corresponding to various functions of the ion trap.

Depending on factors such as the charge on the at least one atomic object and/or the shape and/or magnitude of the combined electrical and/or magnetic fields, the at least one atomic object can be stabilized at a particular distance (e.g., approximately 20 μm to approximately 200 μm) above an upper surface of the ion trap 110 (e.g., the coplanar upper surface of the sequences of TT electrodes 114 and RF rails 112). To further contribute to controlling the transit of atomic objects along desired trajectories, the ion trap 110 may be operated within a cryogenic and/or vacuum chamber capable of cooling the ion trap to a temperature of less than 124 Kelvin (e.g., less than 100 Kelvin, less than 50 Kelvin, less than 10 Kelvin, less than 5 Kelvin, and/or the like), in various embodiments.

In various embodiments, the RF rails 112, the sequences of electrodes 114, and/or the confinement potential generated by the RF rails and/or the sequences of electrodes 114 define a confinement plane 103 of the ion trap. In various embodiments, the RF rails 112, the sequences of electrodes 114, and/or the confinement potential generated by the RF rails and/or the sequences of electrodes 114 define an axis 101 of the ion trap.

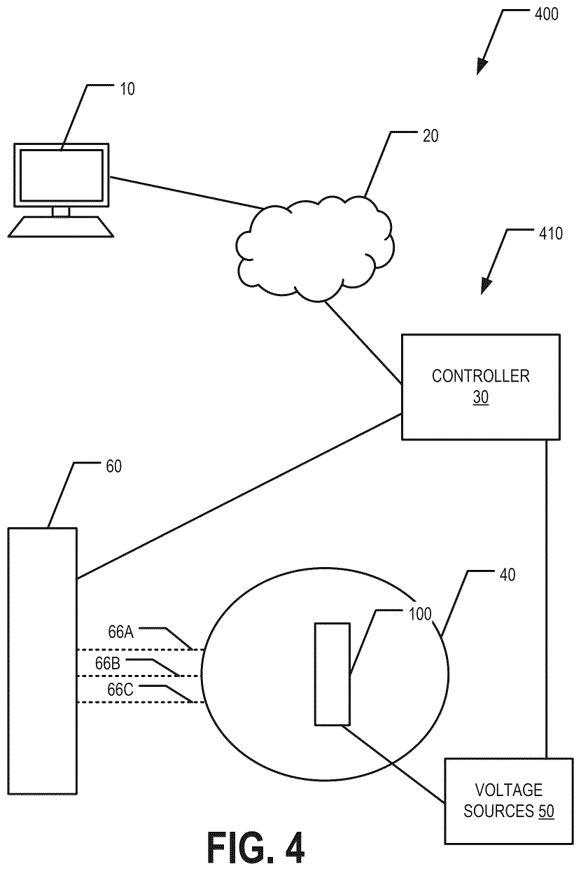

In various embodiments, the TT voltages applied to the TT electrodes 116 are controlled by one or more connected devices (e.g., a controller 30 as shown in FIG. 4 and/or the like) via leads. For example, depending on the positive or negative charge on the at least one atomic object, TT voltages may be raised or lowered for TT electrodes 116 in the vicinity of a particular ion to cause the particular ion to traverse a desired trajectory. For example, a controller 30 may control a voltage driver to cause the voltage driver to apply TT voltages to the TT electrodes to generate a time-dependent electric potential (e.g., an electric potential that evolves with time) that causes various functions of the ion trap to be performed (e.g., transporting atomic objects from one location within the ion trap to another location in the ion trap, maintaining an atomic object in a particular location within the ion trap so that quantum logic gate may be performed on the atomic object, causing two atomic objects to swap positions within the ion trap, cause two atomic objects to move close together, cause two atomic objects that are close together to move apart from one another, and/or the like).

For another example, a controller 30 may control a voltage driver to cause the voltage driver to apply voltage signals to the electrodes to cause phonon pumping of one or more atomic objects within the ion trap.

### Exemplary System

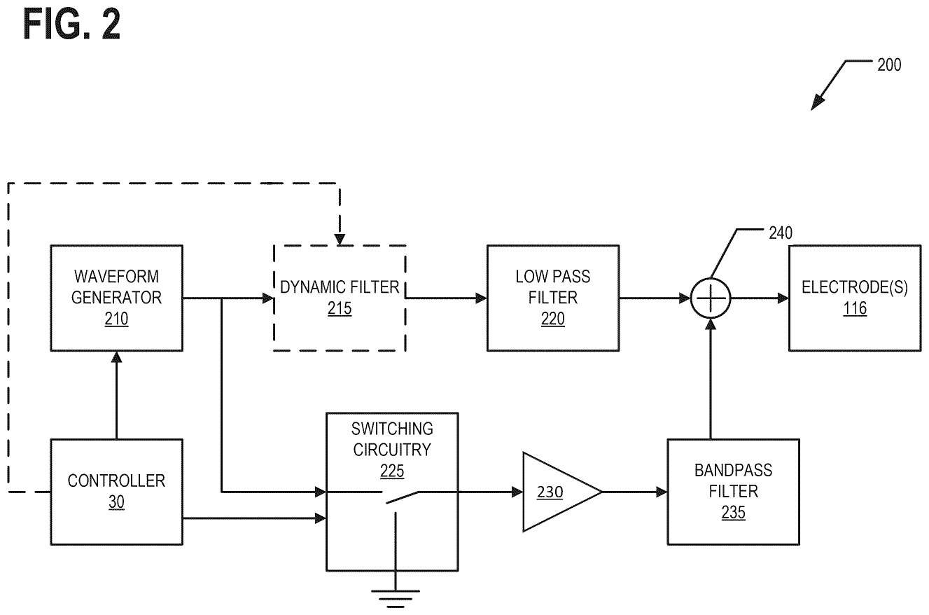

FIG. 2 illustrates an example system 200 for providing dynamic control of a signal applied to an electrical component, in accordance with an example embodiment. In various embodiments, a controller 30 may control one or more waveform generators 210 (also termed signal generators) (e.g., voltage sources 50 shown in FIG. 4) to cause signals (e.g., voltage signals) to be applied to electrical components (e.g., electrodes 116) of a system configured to perform multiple functions. For example, as described above, the application of the signals to the electrodes 116 causes a potential field to be generated that may cause one or more transport functions to be performed on atomic objects captured within an ion trap 100 and/or may cause phonon pumping of one or more atomic objects within the ion trap 100. In an example embodiment, a waveform generator 210 is an arbitrary waveform generator (AWG).

In various embodiments, the system 200 comprises a first signal path and a selectively connected second signal path between the waveform generator 210 and the electrodes 116. In the illustrated embodiment, the first signal path includes a dynamic filter 215 (including but not limited to a dynamic filter as described in U.S. Pat. No. 11,025,228) (the dynamic filter 215 is shown in dashed line to indicate that it is optional) and a low pass filter 220. As described above, the dynamic filter 125 and/or the low pass filter 220 of the first signal path filter undesirable noise from the signal produced by the waveform generator while providing the first frequency component (if present) to the electrodes 116 to cause the desired transport operation. As described in detail in U.S. Pat. No. 11,025,228, the controller 30 controls the dynamic response of the dynamic filter 215. In one example embodiment, the filters of the first signal path block signals above 650 kilohertz (kHz), although any suitable frequency cutoff may be used. In various embodiments, any suitable number, type, and arrangement of filters may be used in the first signal path.

In the illustrated embodiment, the selectively connected second signal path includes a switching circuitry 225, a buffer 230, and a bandpass filter 235. In various embodiments, the frequency range allowed by the bandpass filter 235 (i.e., its passband) corresponds to the frequency used for phonon pumping, plus or minus an error factor. In one example embodiment, the bandpass filter has a passband of 2.2 megahertz (MHz), plus or minus 100 kHz, although any suitable frequency may be used for phonon pumping and therefore any suitable corresponding passband may be used (however, frequencies that interfere with ion transport operations should generally be avoided).

In the illustrated embodiment, the switching circuitry 225 selectively connects the second signal path between the waveform generator 210 and the electrodes 116. In the illustrated embodiment, the switching circuitry 225 is controlled (i.e., closed and opened) by the controller 30. When the switching circuitry 225 is closed, the second signal path is connected between the waveform generator 210 and the electrodes 116. When the switching circuitry 225 is open, the second signal path is not connected between the waveform generator 210 and the electrodes 116, and the buffer 230 is connected to ground.

In various embodiments, if phonon pumping is desired to redistribute the phonon population of an atomic object for more efficient laser cooling, the controller 30 causes the switching circuitry 225 to close to connect the second signal path and the controller 30 causes the waveform generator 210 to generate a signal that includes a second frequency component at a frequency that causes phonon pumping (e.g., 2.2 MHz). The signal generated may or may not also include the first frequency component to cause a desired transport operation (e.g., 300 kHz). In various embodiments, the generated signal will flow to the first signal path and the second signal path. In various embodiments, because the second frequency component is within the passband of the bandpass filter 235, when the switching circuitry 225 is closed the second frequency component will flow through the switching circuitry 225, the buffer 230, and the bandpass filter 235 of the second signal path. If the generated signal also includes a first frequency component, the first frequency component will flow through the dynamic filter 215 (if present) and the low pass filter 220 of the first signal path.

The first frequency component (if present) flowing through the first signal path and the second frequency component flowing through the second signal path (if the switching circuitry 225 is closed) will join at junction 240. When the first frequency component flowing through the first signal path and the second frequency component flowing through the second signal path meet at the junction 240, the two frequency components are joined passively (i.e., there is no active component at the junction 240) or actively (i.e., there is one or more components (e.g., an op-amp) at the junction 240 that actively sums the signals). In some embodiments, when the first frequency component flowing through the first signal path and the second frequency component flowing through the second signal path are passively summed at the junction 240, the output impedance of the low pass filter 220 and of the bandpass filter 235 typically needs to be relatively high.

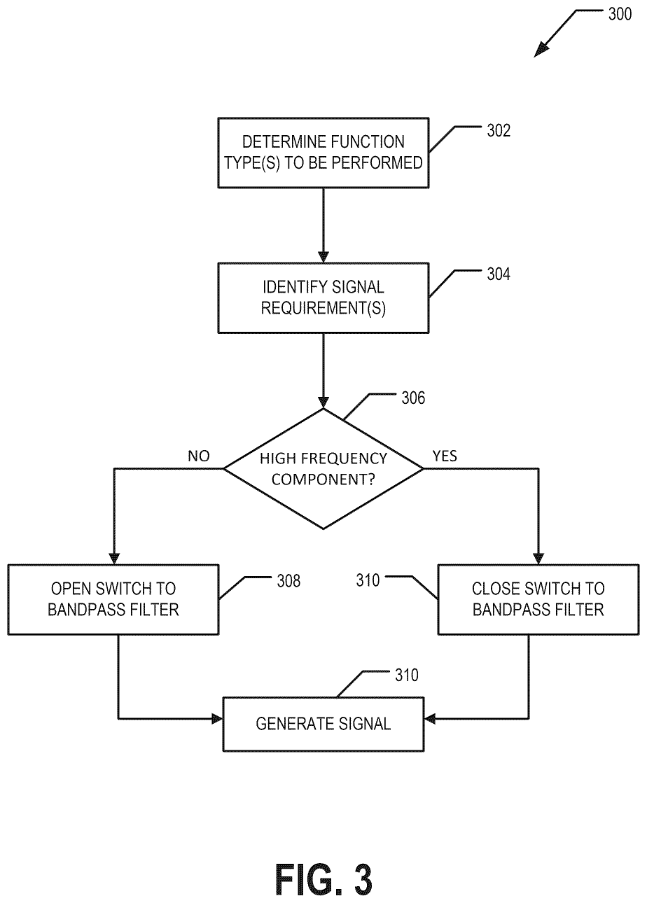

FIG. 3 provides a flowchart illustrating example processes, procedures, operations, and/or the like that may be performed by a controller 30, for example, to dynamically provide a signal to an electrical component (e.g., electrodes 116) via a first signal path and a selectively connected second signal path with a bandpass filter (e.g., bandpass filter 235) between a signal generator (e.g., waveform generator 210) and the electrical component. For the sake of clarity, we focus on the application of a signal to a single electrode 116. However, as should be understood, a system may comprise a plurality of waveform generators 210, a plurality of first signal paths, and a plurality of second signal paths with bandpass filters 235 such that signals may be dynamically provided to a plurality of electrodes 116 and/or other electrical components.

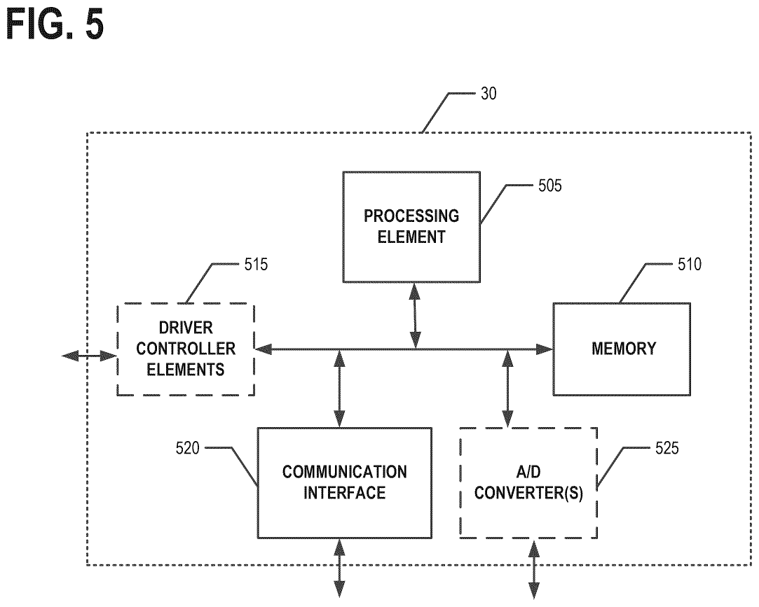

Starting at step/operation 302, a function type(s) to be performed is/are identified. For example, the controller 30 (e.g., using processing element 505 shown in FIG. 5) may read a next command from a command queue. For example, the command may indicate that a particular set of voltages should be applied to a set of electrodes 116 to perform a particular function, such as a transport operation and/or phonon pumping.

At step/operation 304, the signal requirement(s) for the identified function(s) to be performed is/are determined. For example, if the function to be performed is an ion transport operation, the signal will comprise a first frequency component having a first range of frequencies that will cause the desired transport operation. Similarly, if the function to be performed is a phonon pumping operation, the signal will comprise a second frequency component having a second range of frequencies that will cause the desired phonon pumping. If, for example, an ion transport operation and a phonon pumping operation are to be performed, the signal will comprise such a first frequency component having a first range of frequencies and such a second frequency component having a second range of frequencies.

At step/operation 306, the controller 30 determines if the signal to be generated will include a frequency component that needs to use the selectively connectable second signal path to reach the electrodes 116. For example, if the signal to be generated will include a second frequency component having a second range of frequencies that will cause phonon pumping (and which would therefore be filtered out in the first signal path), then the second signal path will need to be selectively connected to enable the second frequency component to reach the electrodes 116.

If it is determined at step/operation 306 that the signal to be generated will not include a frequency component that needs to use the selectively connectable second signal path to reach the electrodes 116, then, at step/operation 308, the controller 30 will open a switch (e.g., switching circuitry 225) such that the second signal path is not connected between the waveform generator 210 and the electrodes 116.

If it is determined at step/operation 306 that the signal to be generated will include a frequency component that needs to use the selectively connectable second signal path to reach the electrodes 116, then, at step/operation 310, the controller 30 will close a switch (e.g., switching circuitry 225) such that the second signal path is connected between the waveform generator 210 and the electrodes 116.

At step/operation 310, the controller 30 causes the waveform generator 210

corresponding to the electrodes to generate signals in accordance with the command and provide the signals to the first and second signal paths.

In various embodiments, the process then returns to step/operation 302 and another command is read corresponding to another function. The next function(s) to be performed may or may not have a second frequency component and the switch in the second signal path will be opened or closed accordingly. As such, the process shown in FIG. 3 may be repeated as required for the controller 30 to cause the system to perform the desired functions.

### Exemplary Quantum Computer Comprising an Ion Trap Apparatus

As described above, the example system 200 for providing dynamic control of a signal applied to an electrical component may be part of a quantum computer. For example, the first signal path may be used to provide a signal having a first frequency component being applied to electrodes 116 of an ion trap that traps atomic objects used as the qubits of the quantum computer, while the second signal path may be used to provide a second frequency component to control phonon pumping of those atomic objects. FIG. 4 provides a schematic diagram of an example quantum computer system 400 comprising a confinement apparatus (e.g., ion trap 100), in accordance with an example embodiment. In various embodiments, the quantum computer system 400 comprises a computing entity 10 and a quantum computer 410. In various embodiments, the quantum computer 410 comprises a controller 30, a cryostat and/or vacuum chamber 40 enclosing a confinement apparatus (e.g., ion trap 100), and one or more manipulation sources 60. In an example embodiment, the one or more manipulation sources 60 may comprise one or more lasers (e.g., optical lasers, microwave sources, and/or the like). Beams, pulses, fields, and/or the like generated by the manipulation sources 60 may be provided to the ion trap 100 via one or more optical paths 66 (e.g., 66A, 66B, 66C) in an example embodiment. In various embodiments, the one or more manipulation sources 60 are configured to manipulate and/or cause a controlled quantum state evolution of one or more atomic objects within the confinement apparatus. For example, in an example embodiment, wherein the one or more manipulation sources 60 comprise one or more lasers, the lasers may provide one or more laser beams to the confinement apparatus within the cryogenic and/or vacuum chamber 40. In various embodiments, the quantum computer 410 comprises one or more voltage sources 50. For example, the voltage sources 50 may comprise a plurality of TT voltage drivers and/or voltage sources and/or at least one RF driver and/or voltage source. For example, the voltage sources 50 may comprise one or more waveform generators 210. The voltage sources 50 may be electrically coupled to the corresponding potential generating elements (e.g., TT electrodes 116) of the confinement apparatus (e.g., ion trap 100) via a dynamic filter 215, in an example embodiment.

In various embodiments, a computing entity 10 is configured to allow a user to provide input to the quantum computer 410 (e.g., via a user interface of the computing entity 10) and receive, view, and/or the like output from the quantum computer 410. The computing entity 10 may be in communication with the controller 30 of the quantum computer 410 via one or more wired or wireless networks 20 and/or via direct wired and/or wireless communications. In an example embodiment, the computing entity 10 may translate, configure, format, and/or the like information/data, quantum computing algorithms, and/or the like into a computing language, executable instructions, command sets, and/or the like that the controller 30 can understand and/or implement.

In various embodiments, the controller 30 is configured to control the voltage sources 50, cryogenic system and/or vacuum system controlling the temperature and pressure within the cryogenic and/or vacuum chamber 40, manipulation sources 60, and/or other systems controlling various environmental conditions (e.g., temperature, pressure, and/or the like) within the cryogenic and/or vacuum chamber 40 and/or configured to manipulate and/or cause a controlled evolution of quantum states of one or more atomic objects within the confinement apparatus. For example, the controller 30 may cause a controlled evolution of quantum states of one or more atomic objects within the confinement apparatus to execute a quantum circuit and/or algorithm. In various embodiments, the atomic objects confined within the confinement apparatus are used as qubits of the quantum computer 410.

### Exemplary Controller

In various embodiments, a confinement apparatus is incorporated into a quantum computer 410. In various embodiments, a quantum computer 410 further comprises a controller 30 configured to control various elements of the quantum computer 410. For example, the controller 30 may be configured to control the voltage sources 50, a cryogenic system and/or vacuum system controlling the temperature and pressure within the cryogenic and/or vacuum chamber 40, manipulation sources 60, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more atomic objects within the confinement apparatus.

As shown in FIG. 5, in various embodiments, the controller 30 may comprise various controller elements including processing element 505, memory 510, driver controller elements 515, a communication interface 520, analog-digital converter elements 525, and/or the like. For example, the processing element 505 may comprise programmable logic devices (PLDs), complex PLDs (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing element 505 of the controller 30 comprises a clock and/or is in communication with a clock.

For example, the memory 510 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 510 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 510 (e.g., by a processing element 505) causes the controller 30 to perform one or more steps, operations, processes, procedures and/or the like described herein.

In various embodiments, the driver controller elements 515 may include one or more drivers and/or controller elements each configured to control one or more drivers. In various embodiments, the driver controller elements 515 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element 505). In various embodiments, the driver controller elements 515 may enable the controller 30 to operate a manipulation source 60. In various embodiments, the drivers may be laser drivers; vacuum component drivers; drivers for controlling the flow of current and/or voltage applied to TT, RF, (e.g., voltage sources 50), and/or other electrodes used for maintaining and/or controlling the ion trapping potential of the ion trap 100 and/or for phonon pumping (and/or other driver for providing driver action sequences to potential generating elements of the confinement apparatus); cryogenic and/or vacuum system component drivers; and/or the like. For example, the drivers may control and/or comprise TT and/or RF voltage drivers and/or voltage sources that provide voltages and/or electrical signals to the TT electrodes 116 and/or RF rails 112. In various embodiments, the controller 30 comprises means for communicating and/or receiving signals from one or more optical receiver components such as cameras, MEMs cameras, CCD cameras, photodiodes, photomultiplier tubes, and/or the like. For example, the controller 30 may comprise one or more analog-digital converter elements 525 configured to receive signals from one or more optical receiver components, calibration sensors, and/or the like.

In various embodiments, the controller 30 may comprise a communication interface 520 for interfacing and/or communicating with a computing entity 10. For example, the controller 30 may comprise a communication interface 520 for receiving executable instructions, command sets, and/or the like from the computing entity 10 and providing output received from the quantum computer 410 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Exemplary Computing Entity

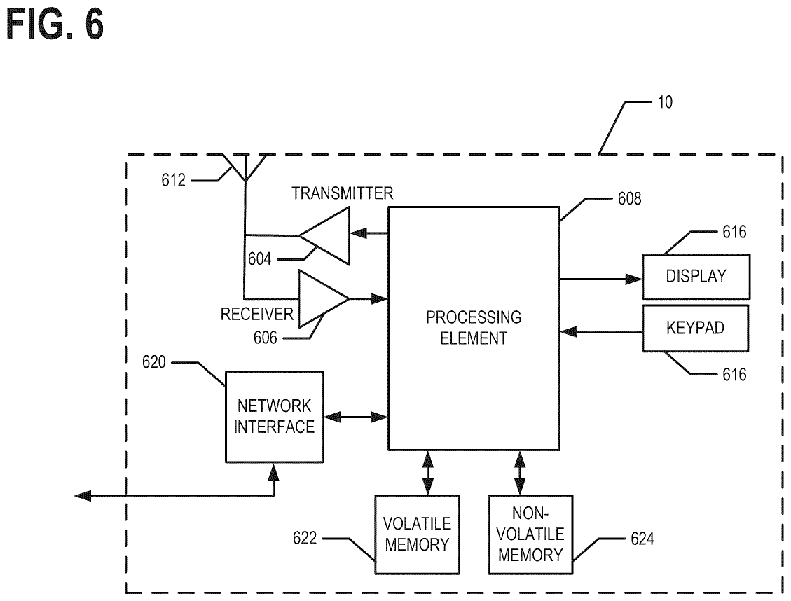

FIG. 6 provides an illustrative schematic representative of an example computing entity 10 that can be used in conjunction with embodiments of the present invention. In various embodiments, a computing entity 10 is configured to allow a user to provide input to the quantum computer 410 (e.g., via a user interface of the computing entity 10) and receive, display, analyze, and/or the like output from the quantum computer 410.

As shown in FIG. 6, a computing entity 10 can include an antenna 612, a transmitter 604 (e.g., radio), a receiver 606 (e.g., radio), and a processing element 608 that provides signals to and receives signals from the transmitter 604 and receiver 606, respectively. The signals provided to and received from the transmitter 604 and the receiver 606, respectively, via a network interface 620, may include signaling information/data in accordance with an air interface standard of applicable wireless systems to communicate with various entities, such as a controller 30, other computing entities 10, and/or the like.

In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

The computing entity 10 may also comprise a user interface device comprising one or more user input/output interfaces (e.g., a display 616 and/or speaker/speaker driver coupled to a processing clement 608 and a touch screen, keyboard, mouse, and/or microphone coupled to a processing element 608). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 618 (hard or soft), a touch display, voice/speech or motion interfaces, scanners, readers, or other input device. In embodiments including a keypad 618, the keypad 618 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 622 and/or non-volatile storage or memory 624, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for providing dynamic signal control, the system comprising:
a signal generator configured to generate a signal comprising a first frequency component having a first range of frequencies and/or a second frequency component having a second range of frequencies, the second range of frequencies being higher than the first range of frequencies;
a controller configured to control operation of the signal generator;
a first signal path between the signal generator and an output connected to an electrode of an ion trap, the ion trap configured to trap a plurality of atomic objects therein, the first signal path comprising at least a low pass filter to filter noise above the first range of frequencies from the signal; and
a selectively connectable second signal path between the signal generator and the output to bypass the low pass filter of the first signal path, the second signal path comprising at least a bandpass filter to permit the second frequency component to pass from the signal generator to the output.

2. The system of claim 1, wherein the first frequency component of the signal controls an atomic object transport operation.

3. The system of claim 2, wherein the atomic object transport operation comprises one or more of transporting an atomic object from one location within the ion trap to another location in the ion trap, maintaining an atomic object in a particular location within the ion trap so that a quantum logic gating operation may be performed on the atomic object, causing two atomic objects to swap positions within the ion trap, causing two atomic objects to move close together, and/or causing two atomic objects that are close together move apart from one another.

4. The system of claim 2, wherein the second frequency component of the signal controls a phonon pumping operation that changes a phonon distribution of an atomic object to decrease a phonon population of the atomic object in a mode that is slower to cool with laser cooling and to increase the phonon population of the atomic object in a mode that is faster to cool with laser cooling.

5. The system of claim 1, wherein the second signal path further comprises switching circuitry to selectively connect the second signal path between the signal generator and the output; and
wherein the controller is further configured to control operation of the switching circuitry.

6. The system of claim 5, wherein the switching circuitry is positioned between the signal generator and the bandpass filter.

7. The system of claim 6, wherein the second signal path further comprises at least one buffer positioned between the switching circuitry and the bandpass filter; and
wherein the switching circuitry switches an input of the at least one buffer to ground when the second signal path is not connected between the signal generator and the output.

8. The system of claim 1, wherein the first signal path and the second signal path are passively joined at the output.

9. The system of claim 1, wherein the first signal path and the second signal path are actively joined at the output.

10. The system of claim 1, wherein the first signal path further comprises a dynamic filter that is capable of switching between at least two responses; and
wherein the controller is further configured to control selection of an operating response from the at least two responses of the dynamic filter, and to cause the activation of one or more switches of the dynamic filter to select the operating response from the at least two responses of the dynamic filter.

11. A method for dynamically providing a signal in a system, the method comprising:
causing, by a controller of the system, a signal generator to generate a signal comprising a first frequency component having a first range of frequencies and/or a second frequency component having a second range of frequencies, the second range of frequencies being higher than the first range of frequencies;
wherein the signal generated by the signal generator is provided to a first signal path between the signal generator and an output connected to an electrode of an ion trap, the ion trap configured to trap a plurality of atomic objects therein, the first signal path comprising at least a low pass filter to filter noise above the first range of frequencies from the signal; and
wherein the signal generated by the signal generator is provided to a selectively connectable second signal path between the signal generator and the output to bypass the low pass filter of the first signal path, the second signal path comprising at least a bandpass filter to permit the second frequency component to pass from the signal generator to the output.

12. The method of claim 11, wherein the first frequency component of the signal controls an atomic object transport operation.

13. The method of claim 12, wherein the atomic object transport operation comprises one or more of transporting an atomic object from one location within the ion trap to another location in the ion trap, maintaining an atomic object in a particular location within the ion trap so that a quantum logic gating operation may be performed on the atomic object, causing two atomic objects to swap positions within the ion trap, causing two atomic objects to move close together, and/or causing two atomic objects that are close together move apart from one another.

14. The method of claim 12, wherein the second frequency component of the signal controls a phonon pumping operation that changes a phonon distribution of an atomic object to decrease a phonon population of the atomic object in a mode that is slower to cool with laser cooling and to increase the phonon population of the atomic object in a mode that is faster to cool with laser cooling.

15. The method of claim 11, wherein the second signal path further comprises switching circuitry to selectively connect the second signal path between the signal generator and the output; and
wherein the method further comprises causing, by the controller of the system, operation of the switching circuitry.

16. The method of claim 15, wherein the switching circuitry is positioned between the signal generator and the bandpass filter.

17. The method of claim 16, wherein the second signal path further comprises at least one buffer positioned between the switching circuitry and the bandpass filter; and
wherein the switching circuitry switches an input of the at least one buffer to ground when the second signal path is not connected between the signal generator and the output.

18. The method of claim 11, wherein the first signal path and the second signal path are passively joined at the output.

19. The method of claim 11, wherein the first signal path and the second signal path are actively joined at the output.

20. The method of claim 11, wherein the first signal path further comprises a dynamic filter that is capable of switching between at least two responses; and
wherein the method further comprises, by the controller of the system, controlling selection of an operating response from the at least two responses of the dynamic filter and causing the activation of one or more switches of the dynamic filter to select the operating response from the at least two responses of the dynamic filter.
